(19) United States
(12) Patent Application Publication
(10) Pub. No.: US 2016/0210111 A1
(43) Pub. Date: Jul. 21, 2016

(54) Apparatus for enabling Control Input Modes and Associated Methods

(71) Applicant: NOKIA TECHNOLOGIES OY, Espoo (FI)

(72) Inventor: Christian Rossing KRAFT, Bangkok (TH)

(21) Appl. No.: 15/025,000

(22) PCT Filed: Sep. 29, 2013
(86) PCT No.: PCT/CN2013/084587

§ 371 Date: Mar. 25, 2016

(51) Int. Cl. G06F 3/16; H04R 1/10; H04R 29/00

(52) U.S. Cl. CPC G06F 3/165; H04R 29/001; H04R 1/1041; G06F 3/162

(57) ABSTRACT

An apparatus comprising: a processor; and a memory including computer program code, the memory and the computer program code configured, with the processor, to cause the apparatus to perform at least the following: determine that one or more earphones of a headset are worn in a first earphone configuration with respect to the ears of a user; and enable, in response to said determination, a first control input mode being configured to enable detection of one or more defined user inputs to control respective one or more functions performable in that particular control input mode.

### TECHNICAL FIELD

The present disclosure relates to user interfaces, associated methods, computer programs and apparatus. Certain disclosed aspects/example embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed aspects/example embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions. Certain aspects/example embodiments may relate to peripheral headsets for (e.g. portable) electronic devices and associated apparatus.

### BACKGROUND

Certain portable electronic devices are provided with input user interfaces which allow the user to control the functionality of the device. For example, some mobile phones can be controlled using a keyboard, touch screen and/or voice control.

The listing or discussion of a prior-published document or any background in this specification should not necessarily be taken as an acknowledgement that the document or background is part of the state of the art or is common general knowledge. One or more aspects/example embodiments of the present disclosure may or may not address one or more of the background issues.

### SUMMARY

In a first aspect, there is provided an apparatus comprising:
a processor; and
a memory including computer program code,
the memory and the computer program code configured, with the processor, to cause the apparatus to perform at least the following:
determine that one or more earphones of a headset are worn in a first earphone configuration with respect to the ears of a user; and
enable, in response to said determination, a first control input mode being configured to enable detection of one or more defined user inputs to control respective one or more functions performable in that particular control input mode.

The determined first earphone configuration may comprise the earphones of the headset being worn on the ears of more than one user.

The one or more functions may be performable using an electronic device (such as a portable electronic device).

The earphone configuration may be related to the particular positioning and/or orientation of at least one earphone with respect to the user's ear. The apparatus itself (or another apparatus associated with the apparatus) may differentiate between different earphone configurations using a detected shape of the user's ear. There may thus be different defined particular control input modes for different earphone configurations.

The apparatus may be configured to enable detection of:
a first set of one of more user inputs in a first control input mode corresponding to a particular first earphone configuration; and
a second different set of one or more user inputs in a second control input mode corresponding to a different first earphone configuration. That is, the apparatus may be considered to differentiate between different earphone configurations. One or more of the one or more inputs of the first set and second different set may or may not comprise at least one common user input.

The apparatus may be configured:
to enable detection of a first set of one of more user inputs in a first control input mode corresponding to a first earphone configuration; and
to disable detection of the first set of one or more user inputs in a second control input mode corresponding to a different first earphone configuration.

The apparatus may be configured to, based on the determined earphone configuration, switch between respective particular application control input modes of the connected electronic device, each particular application control input mode being configured to enable a respective different application, each application having one or more specific defined user inputs which provide for control of one or more respective functions performable using the particular application.

The apparatus may be configured to, based on the determined earphone configuration, switch between respective particular sub-application control input modes of the electronic device, each particular sub-application control input mode being configured to enable a particular sub-function of the particular application to be performed using respective one or more specific defined user inputs for the particular sub-application control input mode.

The apparatus may be configured such that the particular control input mode determines which particular physical components of the electronic device are configured to enable the detection of the user input to control respective one or more functions performable by the electronic device in that particular control input mode.

In a particular control input mode, the physical components configured to enable detection of user input may comprise one or more of:
a touch screen;
a physical keypad; and
a microphone for voice control input.

The apparatus may be configured to:
enable a call control input mode in response to a differentiated one-earphone configuration in which one earphone is inserted into the user's ear; and
enable a music control input mode in response to a differentiated two-earphone configuration in which two earphones are inserted into the user's ears.

The apparatus may be configured to:
enable a manual control input mode in response to a differentiated first-ear-earphone configuration in which one earphone is inserted into a user's ears on a predetermined side, the manual control input mode being configured to allow the user to provide input to the electronic device manually; and
enable a voice-select control input mode in response to a differentiated different-ear-earphone configuration in which one earphone is inserted into the user's ear on the side opposite to the predetermined side, the voice-select control input mode being configured to allow the user to provide input to the electronic device using voice control.

The apparatus may be configured to determine different earphone configurations by determining at least one of:
if any of the one or more earphones are inserted into any ear;
if any of the one or more earphones are inserted into a right ear;
if any of the one or more earphones are inserted into a left ear;
if a right earphone is inserted into a right ear;
if a right earphone is inserted into a left ear;
if a left earphone is inserted into a right ear;
if a left earphone is inserted into a left ear;
if no earphones are inserted into any ear;
if a left earphone is inserted into a left ear and a right earphone is inserted into a right ear;
if multiple earphones are inserted into the ears of different people; and
if multiple earphones are inserted into the ears of the same person.

It will be appreciated that the greater number of factors used to define the earphone configurations, the greater the number of control input modes can be differentiated and used. For example, if the device can detect which ear is used and which earphone is being used, the amount of associated control input modes could be up to 7 in total as 7 different earphone configurations can be differentiated (for a single user):

1. only left earphone in left ear;

2. only left earphone in right ear;

3. only right earphone in left ear;

4. only right earphone in right ear;

5. both earphone inserted with right earphone in right ear and the left earphone in left ear;

6. both earphones inserted with right earphone in left ear and the left earphone in right ear; and

7. no earphones inserted.

If the apparatus can determine (or receive signalling which has determined) which earphone is being used, but not which ear, four earphone configurations can be distinguished:

1. left earphone in any ear;

2. right earphone in any ear;

3. both earphone inserted; and

4. no earphones inserted.

If the apparatus can determine (or receive signalling which has determined) which ear an earphone is being worn on, but not which earphone is being worn, four earphone configurations can be distinguished:

1. any earphone in left ear;

2. any earphone in right ear;

3. any earphone in left ear and any earphone in right ear; and

4. no earphones inserted.

That is, certain example embodiments may distinguish between different earphones of the head set (e.g. such that the left earphone inserted into a particular ear is considered to be a different earphone configuration as the right earphone inserted into the particular ear). Other example embodiments may not distinguish between different earphones of the head set (e.g. such that the left earphone inserted into a particular ear is considered to be the same earphone configuration as the right earphone inserted into the particular ear).

The apparatus may be configured to differentiate (or determine or detect) the earphone configuration or receive an indication of the differentiated earphone configuration from a separate earphone configuration differentiator.

The apparatus (or earphone configuration differentiator) may be configured to differentiate between earphone configurations in which one earphone is being worn and earphone configurations in which two earphones are being worn.

The apparatus (or earphone configuration differentiator) may be configured to differentiate between earphone configurations in which an earphone is being worn on a left ear and earphone configurations in which an earphone is being worn on a right ear.

The apparatus (or earphone configuration differentiator) may comprise one or more of the following to differentiate respective earphone configurations:
a 3-D capacitive sensing sensor;
a pressure detecting sensor;
an optical sensor; and
a touch sensitive sensor.

The earphone configurations may be differentiated using one or more of a 3-D capacitive sensor, a pressure detecting sensor, a touch sensitive sensor, a camera, a proximity sensor, an ambient light sensor and a pressure sensor, for example. A 3-D capacitive sensor may be used to determine/map the position, proximity and/or orientation of the user's ear with respect to one or more earphones. This may involve detecting a user's ear up to a particular distance away from the apparatus (for example up to 3 cm away). An earphone/peripheral headset may comprise one or more of the disclosed sensors to enable the particular control input mode of the connected electronic device.

A pressure detecting user interface may include, for example, a pressure sensitive border around the edge of an earphone configured to detect the presence of a user's ear. A pressure sensor may be configured to determine the pressure between the earphone and the ear. A touch sensor may comprise a layer around the earphone which is sensitive to contact with human skin, for example.

Earphone differentiation may, in certain examples, be performed substantially using one sensing device, such as via a 3-D capacitive sensing user interface, and may be assisted by one or more other sensors, such as a camera or pressure sensor, for example. An example of using a combination of sensing elements may be to use a light sensitive layer at the centre of the earphone (which would detect light when the earphone is not being worn, and not detect light when the earphone is being worn), and a pressure-sensitive layer around the sides of the earphone (which would come in contact with the ear when worn).

The apparatus may be configured to allow a user of the electronic device to calibrate the apparatus by: storing one or more earphone configurations on the electronic device; and associating a particular earphone configuration with a control input mode of the electronic device. For example, a user may be shown figures showing pre-defined specific earphone configurations which can then be user associated with respective control input modes. On other cases, the user may define their own earphone configurations.

The earphone configurations may be preset specific earphone configurations, or variable earphone configurations which can be specifically set by the user. The latter case will allow the user to use earphone configurations which he himself can devise and which do not need to conform to pre-set specific configurations. That is, the user may create their own particular earphone configurations and store them in association with a particular control input mode, such that when the user adopts a particular earphone configuration, the corresponding particular control input mode is enabled.

A said earphone may comprise one or more of:
an earplug configured to be inserted into the ear; and
a headphone configured to be placed close to the ear.

The one or more earphones may be connected to the electronic device by a wireless (e.g. Bluetooth™) or a wired connection.

That apparatus may be the connected electronic device, the peripheral headset, a portable electronic device, a laptop computer, a mobile phone, a Smartphone, a tablet computer, a personal digital assistant, a digital camera, a watch, a server, a non-portable electronic device, a desktop computer, a monitor, a server, a wand, a pointing stick, a touchpad, a touch-screen, a mouse, a joystick or a module/circuitry for one or more of the same.

It will be appreciated that, in addition to enabling a control input mode based on the differentiated earphone configuration, other example embodiments may also be configured to directly control the output of the electronic device. For example, example embodiments may use the differentiated earphone configuration to adapt the audio output (e.g. provide the right and left channels to a used earpiece and disable the unused one) when the user switches between earphone configurations (e.g. from dual ear to single ear listening); or to switch between different audio options within a single (e.g. music application) mode.

Other example embodiments may be configured to pause music when the user removes their headset, and/or to start playing the music when the user puts on their headset.

Other example embodiments may allow the user to disable an enabled control input mode whilst the corresponding earphone configuration is ongoing. For example, although a music application control input mode may be enabled based on a differentiated two-earphone configuration, some example embodiments may allow the user to navigate away from the enabled music application to make a phone call using a phone application (thereby disabling the music application control input more and enabling a phone application control input mode). That is, some example embodiments may be configured to provide a particular control input mode in response to a determined earphone configuration by default, and also to allow the enabled default control input mode to be overridden by further input from the user.

According to a further aspect, there is provided a method comprising:

determining that one or more earphones of a headset are worn in a first earphone configuration with respect to the ears of a user; and
enabling, in response to said determination, a first control input mode being configured to enable detection of one or more defined user inputs to control respective one or more functions performable in that particular control input mode.

According to a further aspect, there is provided a computer program comprising computer program code configured to:
determine that one or more earphones of a headset are worn in a first earphone configuration with respect to the ears of a user; and
enable, in response to said determination, a first control input mode being configured to enable detection of one or more defined user inputs to control respective one or more functions performable in that particular control input mode.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product.

According to a further aspect, there is provided an apparatus comprising:
means for determine configured to determine that one or more earphones of a headset are worn in a first earphone configuration with respect to the ears of a user; and
means for enabling configured to enable, in response to said determination, a first control input mode being configured to enable detection of one or more defined user inputs to control respective one or more functions performable in that particular control input mode.

According to a further aspect, there is provided an apparatus comprising:
a determiner configured to determine that one or more earphones of a headset are worn in a first earphone configuration with respect to the ears of a user; and
an enabler configured to enable, in response to said determination, a first control input mode being configured to enable detection of one or more defined user inputs to control respective one or more functions performable in that particular control input mode.

The present disclosure includes one or more corresponding aspects, example embodiments or features in isolation or in various combinations whether or not specifically stated (including claimed) in that combination or in isolation. Corresponding means and corresponding function units (e.g. a earphone configuration differentiator, a particular control input mode enabler) for performing one or more of the discussed functions are also within the present disclosure.

Corresponding computer programs for implementing one or more of the methods disclosed are also within the present disclosure and encompassed by one or more of the described example embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus comprising a number of electronic components, including memory and a processor according to an example embodiment disclosed herein;

FIG. 2 illustrates an example apparatus comprising a number of electronic components, including memory, a processor and a communication unit according to another example embodiment disclosed herein;

FIG. 3 illustrates an example apparatus comprising a number of electronic components, including memory, and a processor according to another example embodiment disclosed herein;

FIGS. 4a-4c illustrate a first example embodiment configured to enable respective control input modes based on the differentiated earphone configuration;

FIGS. 5a-5d illustrate a further example embodiment configured to enable respective control input modes based on the differentiated earphone configuration;

FIGS. 6a-6b illustrate a further example embodiment configured to enable respective control input modes based on the differentiated earphone configuration;

FIGS. 7a-7b illustrate an example apparatus in communication with a remote server/cloud according to another example embodiment disclosed herein;

FIG. 8 depicts a method according to an example embodiment; and

FIG. 9 illustrates schematically a computer readable medium providing a program.

### DESCRIPTION OF EXAMPLE ASPECTS/EMBODIMENTS

Certain electronic devices provide one or more functionalities. For example, a mobile telephone may be used to make calls and to listen to music.

Generally, such a electronic device is provided with a graphical user interface to control the various functionalities. For example, the user may navigate through a menu or interact with icons in order to select whether, for example, the call function is to be activated or the music player function. For example, to make a call on a touch phone may require that that the user first unlocks the screen, then finds the ‘call application’, then dials. This may require an extensive menu system or a large number of icons, particularly in example embodiments with a large number of options.

Examples disclosed herein may be considered to provide a solution to one or more of the abovementioned issues by providing an apparatus configured to determine that one or more earphones of a headset are worn in a first earphone configuration with respect to the ears of a user; and enable, in response to said determination, a first control input mode being configured to enable detection of one or more defined user inputs to control respective one or more functions performable in that particular control input mode. This apparatus may be provided in the peripheral headset, in the connected electronic device, or even in another device associated with the headset/connected electronic device.

By enabling a particular control input mode, the inputs available to the user may change in response to the earphone configuration. Using the determined earphone configuration to control the particular control input mode of a connected electronic device may provide a user with an intuitive and simple way of controlling input to the electronic device (and thus output from the connected electronic device). For example, it may be natural for a user to use one earphone when making a phone call. Similarly, the user may use two earphones when listening to music. Thus, by differentiating between the two earphone configurations, it is possible to enable a phone call input mode or listening to music input mode.

Accordingly, it may be advantageous for a user to control electronic device functionality simply by using a particular earphone configuration on the portable electronic device. For example, by using an earphone configuration to make available particular control inputs, the user need not, for example, interact with a user interface element of a touch screen of a smartphone whilst listening to music to change the control input mode (e.g. from a music application control input mode to a phone application control input mode), as a simple change of earphone configuration can be used to change the control input mode.

Most users use earphones in a particular way when performing particular tasks. For example, when listening to music, a user will generally use two earphones. Therefore, when this two-earphone configuration is adopted, it may be assumed that the user wishes to listen to music. Therefore, a phone example embodiment may be configured to enable a music player control input mode (e.g. by opening a music player application) without the user having to navigate to that particular control input mode manually using user interface elements/menu.

Of course, it will be appreciated that, for example, a user who tends to use unusual earphone configurations for particular tasks may, with certain example embodiments, associate a particular earphone configuration with a particular control input mode of a electronic device so that, when the particular earphone configuration is adopted subsequently, the correct control input mode is activated.

Other examples depicted in the figures have been provided with reference numerals that correspond to similar features of earlier described examples. For example, feature number 101 can also correspond to numbers 201, 301 etc. These numbered features may appear in the figures but may not have been directly referred to within the description of these particular examples. These have still been provided in the figures to aid understanding of the further examples, particularly in relation to the features of similar earlier described examples.

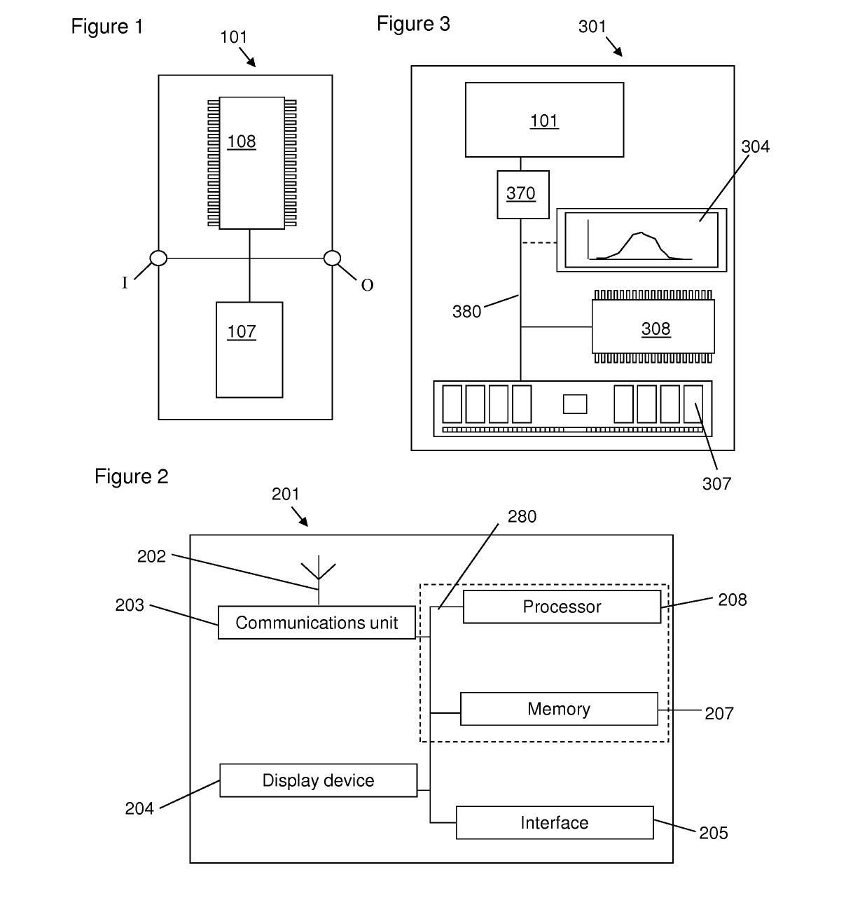

FIG. 1 shows an apparatus 101 comprising memory 107, a processor 108, input I and output O. In this example embodiment only one processor and one memory are shown but it will be appreciated that other example embodiments may utilise more than one processor and/or more than one memory (e.g. same or different processor/memory types).

In this example embodiment the apparatus 101 is an Application Specific Integrated Circuit (ASIC) for a portable electronic device with a touch sensitive display. In other example embodiments the apparatus 101 can be a module for such a device, or may be the device itself, wherein the processor 108 is a general purpose CPU of the device and the memory 107 is general purpose memory comprised by the device.

The input I allows for receipt of signalling to the apparatus 101 from further components, such as components of a portable electronic device (like a touch-sensitive display) or the like. The output O allows for onward provision of signalling from within the apparatus 101 to further components such as a display screen. In this example embodiment the input I and output O are part of a connection bus that allows for connection of the apparatus 101 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 201 of a further example embodiment, such as a mobile phone or even a peripheral headset. In other example embodiments, the apparatus 201 may comprise a module for a mobile phone (or other portable electronic device, or the peripheral headset), and may just comprise a suitably configured memory 207 and processor 208. The apparatus in certain example embodiments could be the peripheral headset, connected electronic device, a portable electronic device, a laptop computer, a mobile phone, a Smartphone, a tablet computer, a personal digital assistant, a digital camera, a navigator, a server, a non-portable electronic device, a desktop computer, a monitor, or a module/circuitry for one or more of the same.

The example embodiment of FIG. 2, in this case, comprises a display device 204 such as, for example, a Liquid Crystal Display (LCD), e-Ink or touch-screen user interface. The display device 204 may be a bendable, foldable, and/or rollable flexible display. The display device 204 may be curved (for example as a flexible display screen or as a rigid curved glass/plastic display screen). The display device 204 (and/or the device 201) may be any shape, such as rectangular, square, round, star-shaped or another shape. A device such as device 201 configured for touch user input may be configured to receive touch input via a touch detected on a touch-sensitive screen, on a separate touch-sensitive panel, or on a touch sensitive front window/screen integrated into the device 201, for example. A touch-sensitive element may be any shape, and may be larger than a display screen of the apparatus/device in some examples. For example, a touch sensitive membrane/layer may be located over the display screen, around the edges of the device 201 and possibly around the back of the device 201. A touch sensitive membrane/layer may include holes, for example to be located over a speaker, camera or microphone of the device so as not to block/cover these input/output devices.

The apparatus 201 of FIG. 2 is configured such that it may receive, include, and/or otherwise access data. For example, this example embodiment 201 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 201 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data). In other cases where the apparatus 201 is a peripheral device, the communication unit 203 and/or antenna 202 may be configured for Bluetooth™ connection to an electronic device.

In this example embodiment, respective front/rear facing cameras are integrated with the user interface 205. In other example embodiments, respective front/rear cameras may be separate from the interface 205 (but, if required, connected to the user interface 205). It will be appreciated that other example embodiments may comprise a single camera.

FIG. 3 depicts a further example embodiment of an electronic device 301, such as a mobile phone, a portable electronic device, a portable telecommunications device, a server or a module for such a device, the device comprising the apparatus 101 of FIG. 1. The apparatus 101 can be provided as a module for device 301, or even as a processor/memory for the device 301 or a processor/memory for a module for such a device 301. The device 301 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device may be a remote server accessed via the internet by the processor.

The apparatus 101 in FIG. 3 is connected (e.g. electrically and/or wirelessly) to an input/output interface 370 that receives the output from the apparatus 101 and transmits this to the device 301 via data bus 380. Interface 370 can be connected via the data bus 380 to a display 304 (touch-sensitive or otherwise) that provides information from the apparatus 101 to a user. Display 304 can be part of the device 301 or can be separate.

The device 301 also comprises a processor 308 configured for general control of the apparatus 101 as well as the device 301 by providing signalling to, and receiving signalling from, other device components to manage their operation.

Again, the camera(s) may be integrated with the apparatus 101, with the device 301, or be separately connected to the apparatus 101 via the input/output interface 370, for example.

The storage medium 307 is configured to store computer code configured to perform, control or enable the operation of the apparatus 101. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

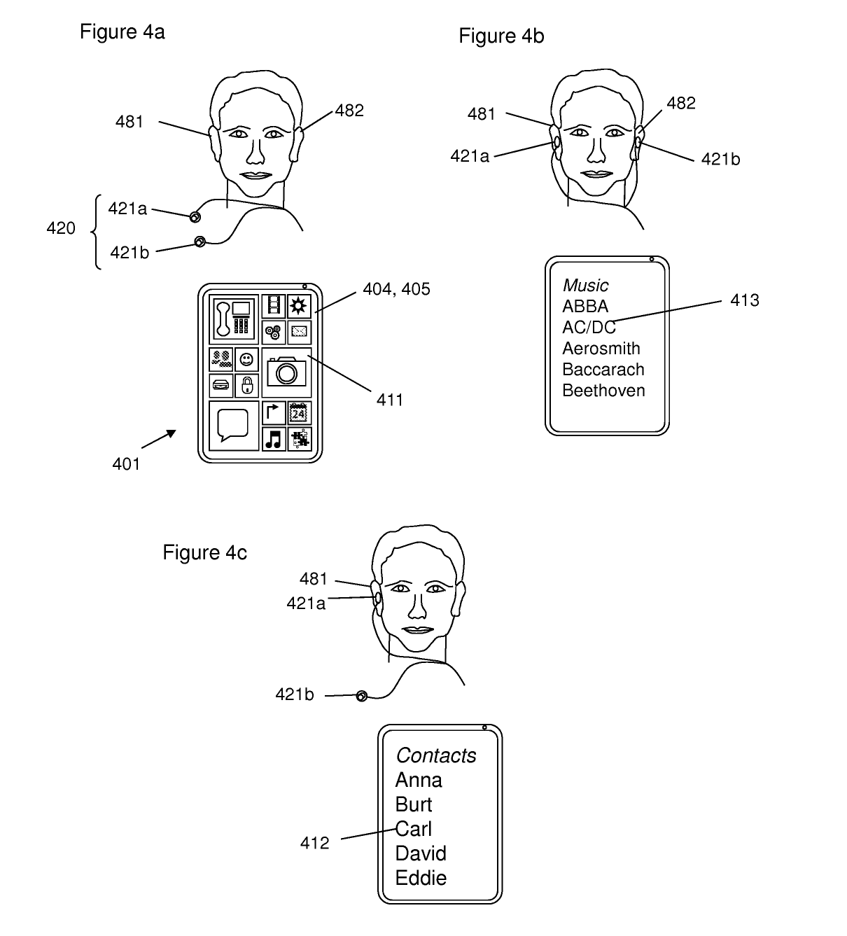

FIGS. 4a-4c illustrate the front of an example embodiment of a portable electronic device 401 such as a mobile telephone or smartphone; and the user of the portable electronic device. The portable electronic device 401 may be the apparatus or may comprise the apparatus. In this case, the portable electronic device is connected, by a wired connection, to a peripheral headset 420 comprising two earplug earphones 421a, 421b, the earplug earphones being configured to be inserted into a user's ear when in use. The user interface of the electronic device, in this case, comprises a touch screen display 404.

In FIG. 4a, the user is not interacting with the earphones 421a, 421b of the headset 420 and the device is in a home screen control input mode. When the device is in a home screen control input mode, a home screen 411 comprising a number of application icons is displayed. By interacting with these application icons, the user can provide inputs to control the functionality of the device. For example, the user can provide a touch input with the music player application icon to open the music player application (thereby entering a music player application control input mode).

In this case, to differentiate/determine the earphone configuration of the peripheral headset, the portable electronic device 401 is configured to receive data from the peripheral headset 420 via the wired connection. The received data, in this case, is generated by pressure sensors (not shown) which form part of each of the two earplug earphones 421a, 421b which form part of the peripheral headset 420.

In this case, the user wishes to listen to music stored on the electronic device 401 using a music player application. In this case, the apparatus/device 401 is configured to enable, based on a determined earphone configuration, with respect to a user's ears 481, 482, of one or more earphones 421a, 421b of a peripheral headset 420, a particular control input mode of a connected electronic device 401, the particular control input mode being configured to enable detection of one or more specific defined user inputs to control respective one or more functions performable by the connected electronic device in that particular control input mode.

To initiate the music application control input mode, the user inserts both of the two earplug earphones 421a, 421b into their ears (as shown in FIG. 4b). Each earphone 421a, 421b is configured to detect the pressure of the respective ear 481, 482 on the earphone using a pressure sensor (not shown). The resulting pressure data is sent to the apparatus (which in this case forms part of the electronic device 401) which determines that both earphones 421a, 421b of the headset 420 have been inserted into the user's ears 481, 482.

Based on the determined two-ear earphone configuration (as shown in FIG. 4b) the apparatus is configured to enable, a particular music application control input mode of the connected electronic device, the particular music application control input mode being configured to enable detection of one or more specific defined user inputs (e.g. relating to selecting tracks and volume control) to control respective one or more music application functions performable by the connected electronic device 401 in that particular music application control input mode.

That is, when the particular music application control input mode is enabled, the user can interact with the touch screen user interface 404, 405 to control the music application. For example, the user can select a particular artist by providing an input the corresponding artist item in the artist list 413 as shown in FIG. 4b. The input may be a touch or hover input provided using the touch screen.

Then the user decides to take a make a phone call. As noted above, the apparatus/device is configured to determine that one or more earphones of a headset are worn in a first earphone configuration with respect to the ears of a user; and enable, in response to said determination, a first control input mode being configured to enable detection of one or more defined user inputs to control respective one or more functions performable in that particular control input mode. In this case, to initiate the call application control input mode, the user of the device removes an earplug earphone 421b to adopt a one-earphone configuration. This is shown in FIG. 4c.

In this case, the apparatus/device determines that the earphone configuration is a one-earphone configuration by detecting pressure from only one of the earphones (in this case, earphone 421a) of the headset 420.

The particular control input mode which is activated is, in this case, based on the determined earphone configuration. In response to determining that the device is in a one-earphone configuration, the device is configured to initiate the call application control input mode. This means that the controls available to the user via the touch screen user interface no longer relate to the music application but to the call application. That is, the available inputs (provided by the contact items displayed on the touch screen) allow the user to select from a number of contacts 412 to initiate a call function. In this way, the apparatus is configured to, based on the determined earphone configuration, switch between respective particular application control input modes of the connected electronic device, each particular application control input mode being configured to enable a respective different application, each application having one or more specific defined user inputs which provide for control of one or more respective functions performable using the particular application.

When the user completes the call, he may remove both earphones 421a, 421b to return to a home screen control input mode. The respective control input modes may be enabled/provided by calling a respective application and putting it into a particular control input mode. This may involve switching from a different application or screen (e.g. a home screen) or even closing a previously running application (e.g. the application in the foreground prior to the differentiated earphone configuration).

It will be appreciated that by adjusting the control input mode, the user need not navigate a (e.g. complex) menu structure to obtain the desired functionality. That is, when one earphone is being used, it may be assumed that the user wishes to use the call application. Likewise, when two earphones are being used, it may be assumed that the user wishes to use a music application. When no earphones are being used, it may be more difficult to know precisely which application is desired, so a home screen control input mode may be enabled by default from where the user can navigate to a desired application.

It will be appreciated, that other example embodiments may be configured to determine the earphone configuration in different ways. For example, the earphone configuration may be determined based on a 3D sensor scan of the surface within a predetermined range of each earphone (e.g. within 3 cm).

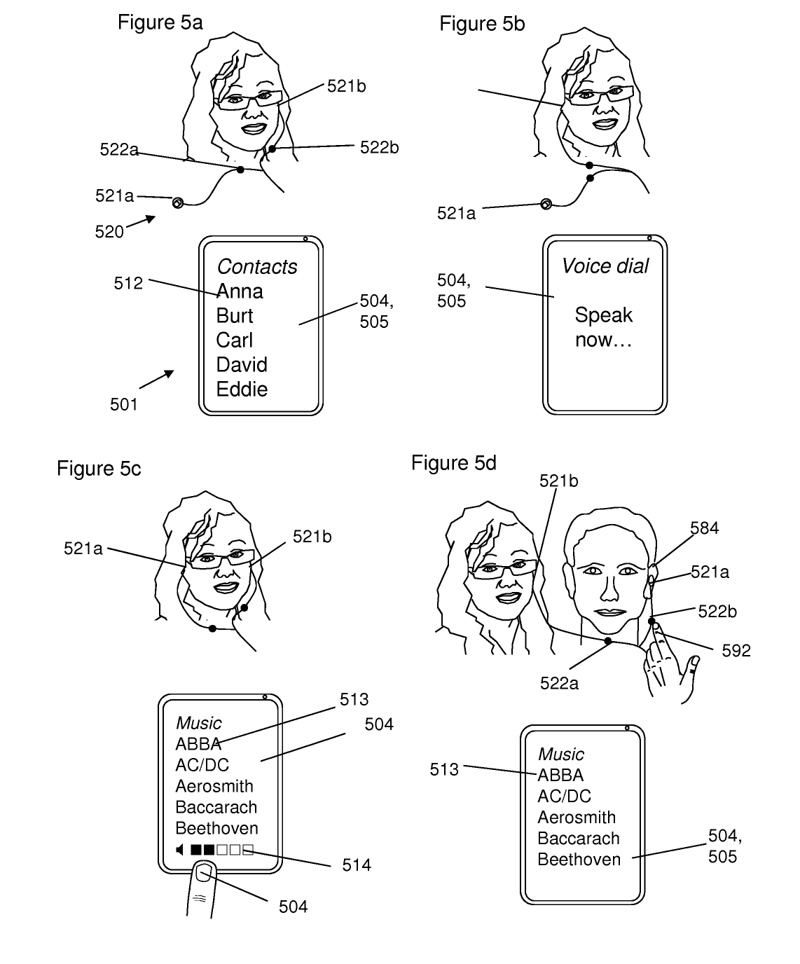

FIGS. 5a-5d illustrate an example of a portable electronic device 501 such as a smartphone; and the user of the portable electronic device. The portable electronic device 501 may be the apparatus or may comprise the apparatus. In this case, the portable electronic device is connected, by a wired connection, to a peripheral headset 520 comprising two earplug earphones 521a, 521b, the earplug earphones being configured to be inserted into a user's ear when in use.

The electronic device 501, in this case can be controlled by different physical components, in particular: a touch screen 504, 505; a microphone for voice control input (not shown); and a physical volume control 522a, 522b in each of the earphones 521a, 521b of the headset 520. In this case, to differentiate the earphone configuration of the peripheral headset, the portable electronic device 501 is configured to receive data from the peripheral headset via a wired connection. The received data, in this case, is generated by 3D capacitive sensors (not shown) which form part of each of the two earplug earphones 521a, 521b which form part of the peripheral headset.

In this case, the apparatus/device 501 is configured to determine that one or more earphones 521a, 521b of a headset are worn in a first earphone configuration with respect to the ears of a user; and enable, in response to said determination, a first control input mode being configured to enable detection of one or more defined user inputs to control respective one or more functions performable in that particular control input mode.

In this case, the user has decided to take a make a phone call. In this case, the phone call control input mode corresponds to a one-earphone configuration. However, in this example embodiment there are two phone call control input modes: a touch screen phone call control input mode, in which the user can control the phone call application using a touch screen physical input component; and voice phone call control input mode, in which the user can control the phone call application using their voice (e.g. using a microphone physical input component and voice recognition software). That is, in this case, the apparatus is configured such that the particular control input mode determines which particular physical components (e.g. microphone, touch screen 504, 505 and/or headset controls 522a, 522b) of the electronic device 501 are configured to enable the detection of the user input to control respective one or more functions performable by the electronic device in that particular control input mode.

In this case, the touch screen phone call control input mode is associated with a left-ear one-earphone configuration; and the voice phone call control input mode is associated with a right-ear one-earphone configuration.

In the situation shown in FIG. 5a, the user has adopted a left-ear one-earphone configuration by inserting one of the earphones 521b into her left ear. In this case, the apparatus can determine whether an earphone has been inserted into a right or left ear using a 3D capacitive ‘image’ of the external ear when the earphone is inserted.

The capacitive sensing technology may be called 3-D touch, hovering touch or touchless touch, and may comprise the capacitive sensor in communication with a host computer/processor. The capacitive field can detect objects such as the ear at the edges/sides of the earphone as it can detect objects at a distance away from the sensor region. Thus, a user's ear may readily be identified, because the user's ear may be detectable by the capacitive field even if they are at the edges and even at the back of the earphone.

When a user inserts an earphone with such a 3-D capacitive sensing user interface into an ear the capacitive field changes. The capacitive raw data may be processed by the electronic device or transmitted to a host computer/processor from the apparatus/device 501 and run an ear detection algorithm at the host.

In response to determining that the device is in a left-ear one-earphone configuration, the device has initiated the touch screen phone call control input mode. This means that the inputs available to the user allow the user to use the touch screen to select which contact from a list of contacts 512 to call.

The user then decides that it may be easier to select the desired contact using voice control input so that her hands are free (e.g. to look for her diary). She therefore switches the earphone 521b which was in her left ear to her right ear (FIG. 5b), thereby adopting a right-ear one-earphone configuration. In response to determining that the device is in a right-ear one-earphone configuration, the device is configured to initiate the voice phone call control input mode. This means that the controls available to the user allow the user to use the microphone (and voice recognition software) to select which contact to call. In this example embodiment, when the voice phone call control input mode is active, the touch screen is disabled (so that a user can not provide control input via the touch screen). It will be appreciated that other example embodiments may be configured to allow multiple control input physical components to be active simultaneously.

The embodiments of FIGS. 5a and 5b can be considered to allow for switching between respective particular sub-application control input modes of the electronic device, each sub-application control input mode being configured to enable a particular sub-set of the particular (calling) application. Also, different physical components (e.g. microphone for voice control) are enabled in a particular control input mode.

After the call has been completed, the user has decided to listen to music using a music application. In this case, the music application control input mode corresponds to a two-earphone configuration. That is, the apparatus is configured to, based on the determined earphone configuration, switch between respective particular application control input modes of the connected electronic device, each particular application control input mode being configured to enable a respective different application, each application having one or more specific defined user inputs which provide for control of one or more respective functions performable using the particular application.

However, in this example embodiment there are two music application control input modes: a touch screen music application control input mode, in which the user can control the music application using a touch screen physical input component; and headset music control input mode, in which the user can control the music application (at least partially) using the headset control. That is, in this case, the apparatus is configured such that the particular control input mode determines which particular physical components (e.g. microphone, touch screen 504, 505 and/or headset control 522a, 522b) of the electronic device 501 are configured to enable the detection of the user input to control respective one or more functions performable by the electronic device in that particular control input mode.

In this case, the touch screen music application control input mode is associated with a different-sides two-earphone configuration, wherein one earphone is in a left ear and the other earphone is in a right ear; and the headset music application control input mode is associated with a same-sides two-earphone configuration, wherein both earphones have been inserted into a left ear, or into a right ear.

In the situation shown in FIG. 5c where the user has adopted a different-side two-earphone configuration by inserting both of the earphones 521a, 521b into her own ears. In this case, the apparatus can differentiate between ear configurations by determining whether an earphone has been inserted into a right or left ear using a 3D image of the external ear when the earphone is inserted. In response to determining that the device is in a different-side two-earphone configuration, the device is configured to initiate the touch screen music application control input mode (as shown in FIG. 5c). This means that the control inputs available to the user allow the user to use the touch screen to select which track to play from the track list 513, and to select the volume of the music by interacting with the touch screen volume control 514 using a stylus (such as a finger 491).

The user then joined by a friend (as shown in FIG. 5d) who would like to hear what she is listening to. She therefore gives the earphone 521b which was in her right ear to her friend, who inserts it into his left ear 522b (so that both earphones are in the left ears of the listeners). This is shown in FIG. 5d. In response to determining that the device is in a same-side two-earphone configuration, the device has initiates the headset music application control input mode. This means that the controls available to the users allow the user to control the volume of each earphone independently using the respective headset controls 522a, 522b. It will be appreciated that, in this case, when the device is in the headset music application control input mode, the users can still select which track is playing using the track list 513 shown on the touch screen user interface. That is, in this case, one or more of the one or more inputs of the headset music application control input mode and of the touch screen music application control input mode have at least one user input in common.

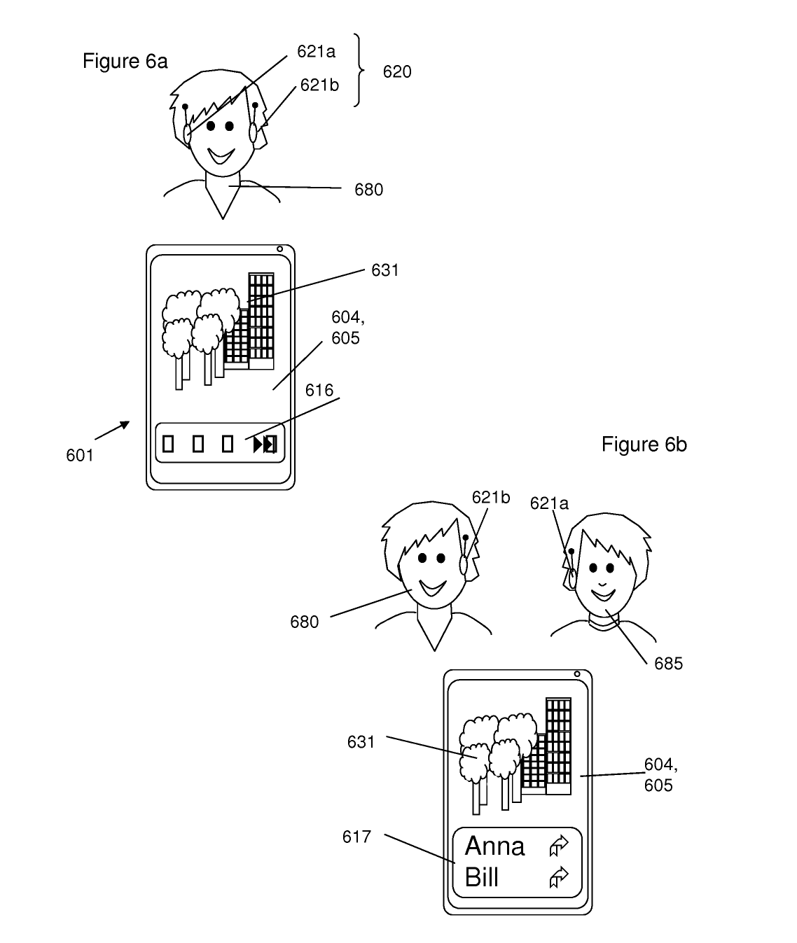

FIGS. 6a-6b illustrate an example of a portable electronic device 601 such as a mobile phone; and the user of the portable electronic device. The portable electronic device 601 may be the apparatus or may comprise the apparatus. In this case, the portable electronic device is connected, by a wireless connection, to a peripheral headset 620 comprising two earplug earphones 621a, 621b, the earplug earphones being configured to be inserted into a user's ear when in use.

The electronic device, in this case, comprises a touch screen 604, 605 with which the user can interact to control the device. In this case, to differentiate the earphone configuration of the peripheral headset, the portable electronic device 601 is configured to receive data from the peripheral headset via the wireless connection. The received data, in this case, is generated by pressure sensors (not shown) which form part of each of the two external earphones 621a, 621b (earphones which are configured to be positioned on the outside of the ear) which form part of the peripheral headset 620.

In this case, the apparatus/device 601 is configured to determine that one or more earphones of a headset are worn in a first earphone configuration with respect to the ears of a user; and enable, in response to said determination, a first control input mode being configured to enable detection of one or more defined user inputs to control respective one or more functions performable in that particular control input mode.

As shown in FIG. 6a, the user is watching an online video 631 using a web browser application. In this case, there are two web browser application control input modes: a personal web browser application control input mode, in which the user can control the playing of the video; and a sharing web browser application control input mode, in which the user can control the sharing of web content. That is, in this case, the apparatus is configured to switch, based on the determined earphone configuration, between respective particular sub-application control input modes of the electronic device, each particular sub-application control input mode being configured to enable a particular sub-function of the particular application to be performed using respective one or more specific defined user inputs for the particular sub-application control input mode.

In this case, the personal web browser application control input mode is associated with each of the earphones being positioned in proximity to the ears of one user (this may be determined, for example, by storing the ear shapes of both ears of particular users, or by comparing the sizes of the two detected ears).

In the situation shown in FIG. 6a, the user has adopted a personal one-earphone configuration by placing one of the earphones 621a, 621b close to each of his ears. In this case, the apparatus can determine whether an earphone has been inserted into a right or left ear using a 3D capacitive ‘image’ of the external ear when the earphone is inserted.

In response to determining that the device is in a personal one-earphone configuration, the device is configured to initiate the personal web browser application control input mode. This means that the controls 616 available to the user (provided by the web browser application) allow the user to use the touch screen to change the volume of the video, play the video, rewind the video and fast forward the video.

Whilst the user 680 is watching the video, he is joined by a friend who also would like to watch the video. The user 680 therefore gives his friend 685 one of the earphones 621a, thereby adopting a sharing earphone configuration wherein each of the earphones of the headset is in proximity to an ear of a different user (user 680 and user 685). In response to determining that the device is in a sharing earphone configuration, the device is configured to initiate the sharing web browser application control input mode (as shown in FIG. 6b). This means that the controls available to the user allow the user to share web content with other users (e.g. with the friend 685 who is also watching the video). For example, in the web browser application control input mode, rather than the video controls being displayed, sharing controls are displayed. In response to the user selecting one of the contacts from the contact list 617, the electronic device 601 is configured to transmit the website address which is currently being viewed to the selected contact.

The previous examples have considered different earplug configurations. It will be appreciated that different headphone configurations can also be used to enable control input modes. For example, particular configurations for a headset which is placed over at least one ear, rather than in an ear may be differentiated to enable a particular control input mode.

The above described embodiments relate to peripheral headsets. It will be appreciated that in other example embodiments the apparatus/electronic device may comprise the headset.

In general, the apparatus is configured to provide functionality as disclosed herein to a wide range of devices, including portable electronic devices such as mobile telephones, personal digital assistants, tablet computers, desktop computers, navigation devices, e-books, personal media players, servers, microphones, speakers, displays, cameras, and non-portable electronic devices such as desktop computers or a module for one or more of the same.

Enabling particular control input mode in this way may allow the user to easily change the operating mode of the device by using headset. This may also allow faster access to key functions related to the headset.

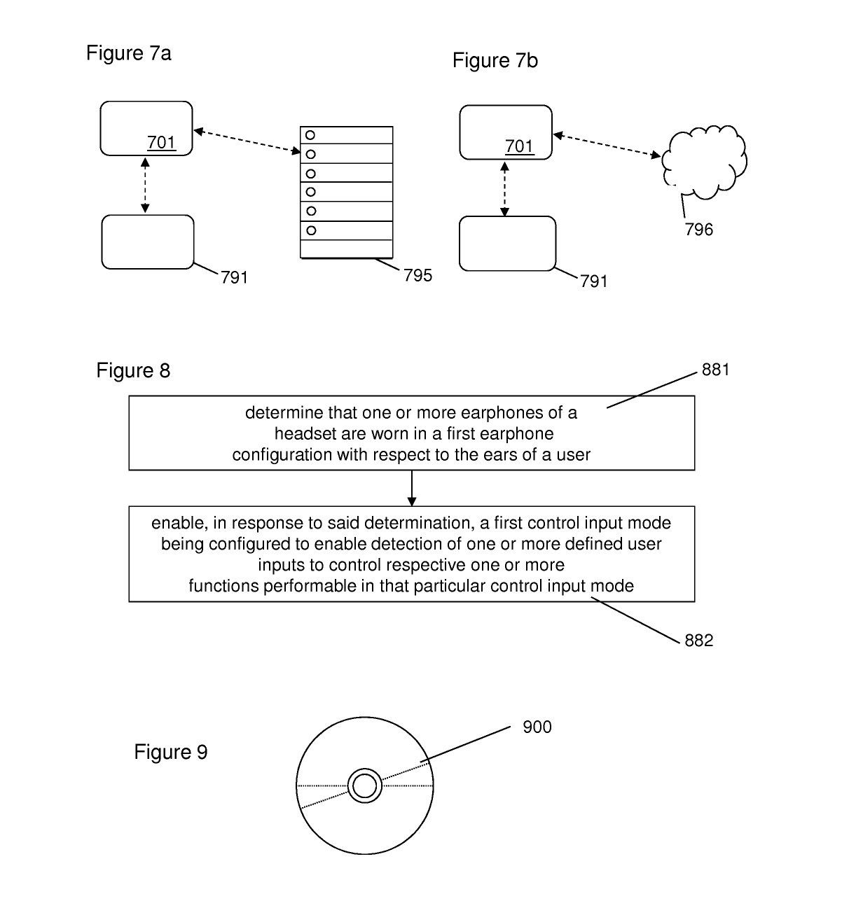

FIG. 7a shows an example of an apparatus in communication with a remote server. FIG. 7b shows an example of an apparatus in communication with a “cloud” for cloud computing. Such communication with a remote computing element may be via a communications unit, for example. In FIGS. 7a and 7b, the apparatus 701 (which may be apparatus 101, 201 or 301) is in communication with another device 791, such as a display, microphone, speaker, or camera. Of course, the apparatus 701 and device 791 may form part of the same apparatus/device, although they may be separate as shown in the figures.

FIG. 7a shows the remote computing element to be a remote server 795, with which the apparatus may be in wired or wireless communication (e.g. via the internet, Bluetooth, a USB connection, or any other suitable connection as known to one skilled in the art). In FIG. 7b, the apparatus 701 is in communication with a remote cloud 796 (which may, for example, by the Internet, or a system of remote computers configured for cloud computing). A portable electronic device may be configured to download data from a remote server 795 or a cloud 796. The determination of the earphone configuration may be performed by the server 795/cloud 796. In other example embodiments, the server 795/cloud 796 may control the control input mode of the electronic device as disclosed herein.

FIG. 8 illustrates a method according to an example embodiment of the present disclosure. The method comprises determining 881 that one or more earphones of a headset are worn in a first earphone configuration with respect to the ears of a user; and enabling 882, in response to said determination, a first control input mode being configured to enable detection of one or more defined user inputs to control respective one or more functions performable in that particular control input mode.

FIG. 9 illustrates schematically a computer/processor readable medium 900 providing a program according to an example embodiment. In this example, the computer/processor readable medium is a disc such as a Digital Versatile Disc (DVD) or a compact disc (CD). In other example embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some example embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such example embodiments can include a reduced requirement to download data when further functionality is required for a device, and this can be useful in examples where a device is perceived to have sufficient capacity to store such pre-programmed software for functionality that may not be enabled by a user.

Any mentioned apparatus/elements/processor may have other functions in addition to the mentioned functions, and that these functions may be performed by the same apparatus/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some example embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/example embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or example embodiments may be incorporated in any other disclosed or described or suggested form or example embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-18. (canceled)

19. An apparatus comprising:
a processor; and
a memory including computer program code,
the memory and the computer program code configured, with the processor, to cause the apparatus to perform at least the following:
determine that one or more earphones of a headset are worn in a first earphone configuration with respect to the ears of a user; and
enable, in response to said determination, a first control input mode being configured to enable detection of one or more defined user inputs to control respective one or more functions performable in that particular control input mode.

20. The apparatus of claim 19, wherein the apparatus is configured to enable detection of:
a first set of one of more user inputs in a first control input mode corresponding to a particular first earphone configuration; and
a second different set of one or more user inputs in a second control input mode corresponding to a different first earphone configuration.

21. The apparatus of claim 20, wherein one or more of the one or more inputs of the first set and second different set comprise at least one common user input.

22. The apparatus of claim 19, wherein the apparatus is configured to, based on the determined earphone configuration, switch between respective particular application control input modes of the connected electronic device, each particular application control input mode being configured to enable a respective different application, each application having one or more specific defined user inputs which provide for control of one or more respective functions performable using the particular application.

23. The apparatus of claim 19, wherein the apparatus is configured to, based on the determined earphone configuration, switch between respective particular sub-application control input modes of the electronic device, each particular sub-application control input mode being configured to enable a particular sub-function of the particular application to be performed using respective one or more specific defined user inputs for the particular sub-application control input mode.

24. The apparatus of claim 19, wherein the apparatus is configured such that the particular control input mode determines which particular physical components of the electronic device are configured to enable the detection of the user input to control respective one or more functions performable by the electronic device in that particular control input mode.

25. The apparatus of claim 24, wherein, in a particular control input mode, the physical components configured to enable detection of user input comprise one or more of:
a touch screen;
a physical keypad; and
a microphone for voice control input.

26. The apparatus of claim 19, wherein the apparatus is configured to:
enable a call control input mode in response to a differentiated one-earphone configuration in which one earphone is inserted into the user's ear; and
enable a music control input mode in response to a differentiated two-earphone configuration in which two earphones are inserted into the user's ears.

27. The apparatus of claim 19, wherein the apparatus is configured to:
enable a manual control input mode in response to a differentiated first-ear-earphone configuration in which one earphone is inserted into a user's ears on a predetermined side, the manual control input mode being configured to allow the user to provide input to the electronic device manually; and
enable a voice-select control input mode in response to a differentiated different-ear-earphone configuration in which one earphone is inserted into the user's ear on the side opposite to the predetermined side, the voice-select control input mode being configured to allow the user to provide input to the electronic device using voice control.

28. The apparatus of claim 26, wherein the differentiated earphone configurations are at least one of:
if any of the one or more earphones are inserted into any ear;
if any of the one or more earphones are inserted into a right ear;
if any of the one or more earphones are inserted into a left ear;
if a right earphone is inserted into a right ear;
if a right earphone is inserted into a left ear;
if a left earphone is inserted into a right ear;
if a left earphone is inserted into a left ear; if no earphones are inserted into any ear;
if a left earphone is inserted into a left ear and a right earphone is inserted into a right ear;
if multiple earphones are inserted into the ears of different people; and
if multiple earphones are inserted into the ears of the same person.

29. The apparatus of claim 19, wherein the apparatus is configured to differentiate the earphone configuration or receive an indication of the differentiated earphone configuration from a separate earphone configuration differentiator.

30. The apparatus of claim 19, wherein the apparatus comprises one or more of the following to differentiate respective earphone configurations:
3-D capacitive sensing user interface;
a pressure detecting user interface;
an optical sensor; and
a touch sensitive user interface.

31. The apparatus of claim 19, wherein the apparatus is configured to allow a user of the electronic device to calibrate the apparatus by:
storing one or more earphone configurations on the electronic device; and
associating a particular earphone configuration with a control input mode of the electronic device.

32. The apparatus of claim 19, wherein a said earphone comprises one or more of:
an earplug configured to be inserted into the ear; and
a headphone configured to be placed close to the ear.

33. The apparatus of claim 19, wherein the one or more earphones are connected to the electronic device by a wireless or wired connection.

34. The apparatus of claim 19, wherein the apparatus is the connected electronic device, the peripheral headset, a portable electronic device, a laptop computer, a mobile phone, a Smartphone, a tablet computer, a personal digital assistant, a digital camera, a watch, a server, a non-portable electronic device, a desktop computer, a monitor, a server, a wand, a pointing stick, a touchpad, a touch-screen, a mouse, a joystick or a module/circuitry for one or more of the same.

35. A method comprising:
determining that one or more earphones of a headset are worn in a first earphone configuration with respect to the ears of a user; and
enabling, in response to said determination, a first control input mode being configured to enable detection of one or more defined user inputs to control respective one or more functions performable in that particular control input mode.

36. A non-transitory computer readable medium comprising computer program code configured to:
determine that one or more earphones of a headset are worn in a first earphone configuration with respect to the ears of a user; and
enable, in response to said determination, a first control input mode being configured to enable detection of one or more defined user inputs to control respective one or more functions performable in that particular control input mode.
